(19) United States
(12) Patent Application Publication
(10) Pub. No.: US 2026/0192454 A1
(43) Pub. Date: Jul. 9, 2026

(54) ROBOT CONTROL DEVICE

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 19/130,535

(22) PCT Filed: Nov. 28, 2022
(86) PCT No.: PCT/JP2022/043723

§ 371 Date: May 15, 2025

(51) Int. Cl. B25J 9/16; B25J 13/08

(52) U.S. Cl. CPC B25J 9/1674; B25J 13/085

(57) ABSTRACT

Provided is a robot control device capable of continuing the operation of a robot when contact is detected. This robot control device comprises: a program management unit that executes a robot program that includes a contact skip motion instruction, the contact skip motion instruction including an external force threshold for stopping the robot when the robot has detected an external force; and a contact motion execution unit that, when the external force detected by the robot exceeds the external force threshold during movement of the robot, stops the movement of the robot in response to the contact skip motion instruction, and executes the next instruction block of the robot program.

### TECHNICAL FIELD

The present disclosure relates to a robot control device.

### BACKGROUND ART

In the related arts, a technique related to a cooperative robot that detects contact with a person and stops operation has been disclosed.

For example, a technique of setting payload information of a workpiece that is held in order to accurately measure a contact force of a cooperative robot has been disclosed.

Further, technology related to a system for manipulating a robot from a machine tool in order to automate a machining site has been disclosed. For example, a technique of performing an operation of a robot using a numerical control command familiar to a user of a machine tool has been disclosed (for example, see Patent Document 1).

### CITATION LIST

### Patent Document

Patent Document 1: Japanese Unexamined Patent Application, Publication No. 2014-241018

### DISCLOSURE OF THE INVENTION

### Problems to be Solved by the Invention

When the robot detects a contact with the object while moving, the robot control device may stop the operation of the robot when the contact is detected, and may be unable to continue the operation of the robot. Therefore, a robot control device capable of continuing the operation of the robot when contact is detected is desired.

### Means for Solving the Problems

According to an aspect of the present disclosure, a robot control device includes: a program management unit that executes a robot program including a contact skip operation command, the contact skip operation command including an external force threshold for stopping a robot when the robot detects an external force; and a contact operation execution unit that, according to the contact skip operation command, when the external force detected by the robot exceeds the external force threshold during a movement of the robot, stops the movement of the robot and executes a next command block of the robot program.

### BRIEF DESCRIPTION OF THE DRAWINGS

FIG. 1 is a functional block diagram of a numerical control system according to an embodiment of the present invention,

FIG. 2 is a functional block diagram of a numerical control device and a robot control device according to the present embodiment;

FIG. 3 is a diagram showing an example of a robot program according to the present embodiment; and

FIG. 4 is a diagram schematically showing an operation of the robot when the robot program shown in FIG. 3 is executed.

### PREFERRED MODE FOR CARRYING OUT THE INVENTION

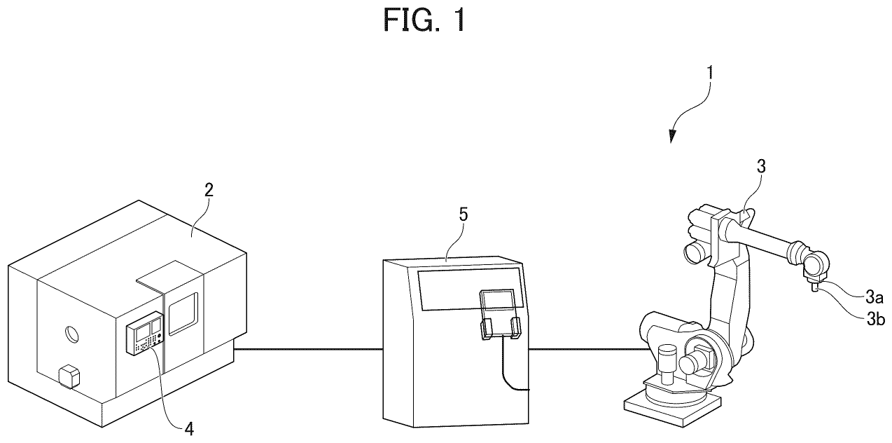

Hereinafter, an example of an embodiment of the present disclosure will be described. FIG. 1 is a functional block diagram of a numerical control system 1 according to an embodiment of the present disclosure.

The numerical control system 1 includes a machine tool 2 that machines a workpiece (not shown), a numerical control device (CNC) 4 that controls the operation of the machine tool 2, a cooperative robot 3 provided in the vicinity of the machine tool 2, and a robot control device 5 that controls the operation of the cooperative robot 3. The numerical control system 1 controls the operations of the machine tool 2 and the cooperative robot 3 in conjunction with each other by using the numerical control device 4 and the robot control device 5 which are communicably connected to each other.

The machine tool 2 machines a workpiece (not shown) in response to a machine tool control signal transmitted from the numerical control device 4. Here, the machine tool 2 is, for example, a lathe, a ball mill, a milling machine, a grinding machine, a laser machining machine, or an injection molding machine, but is not limited thereto.

The cooperative robot 3 operates under the control of the robot control device 5, and performs a predetermined operation on a workpiece to be machined by the machine tool 2, for example. The cooperative robot 3 is, for example, an articulated robot, in which a tool 3b for gripping, machining, or inspecting a workpiece is attached to an arm tip portion 3a thereof. Hereinafter, a case where the cooperative robot 3 is a six-axis articulated robot will be described, but the present invention is not limited thereto. In the following description, the cooperative robot 3 is a six-axis articulated robot, but the number of axes is not limited thereto.

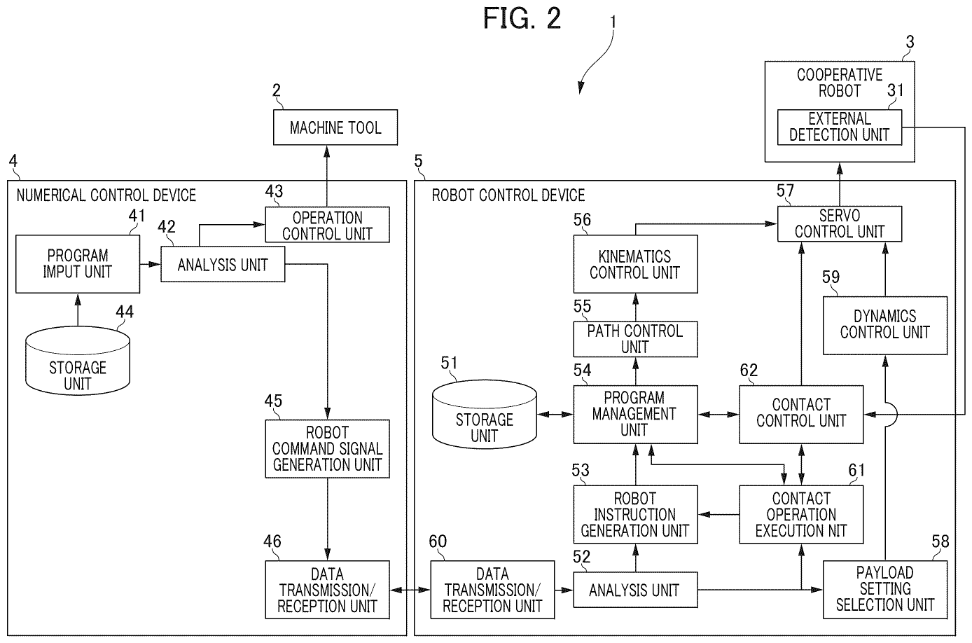

The cooperative robot 3 has functions such as a contact stop function, a retraction mode function, and a reverse operation function, and can work safely in cooperation with a person. The contact stop function is a function of stopping immediately when the cooperative robot 3 comes into contact with the person with a light force (for example, 10 to 20 N (i.e., 1 to 2 kgf)). The retraction mode function is a function in which a person can retract the arm of the cooperative robot 3 in each axis by pressing the arm. The reverse operation function is a function of reducing pinching by immediately reversing the arm when the cooperative robot 3 comes into contact with a hard object. The cooperative robot 3 includes an external force detection unit 31 (see FIG. 2) including an external force detection sensor or the like in order to detect an external force such as contact with a person. The external force detection sensor is, for example, a torque sensor, a force sensor, or the like. That is, the cooperative robot 3 detects a contact with a person by the external force detection sensor, and the robot control device 5 stops the operation of the cooperative robot 3 in response to the external force detected by the external force detection sensor. Accordingly, the cooperative robot 3 can work safely in cooperation with a person.

Each of the numerical control device 4 and the robot control device 5 is a computer configured by hardware such as an arithmetic processing unit such as a CPU (Central Processing Unit), an auxiliary storage unit such as an HDD (Hard Disk Drive) or an SSD (Solid State Drive) storing various computer programs, a main storage unit such as RAM (Random Access Memory) for temporarily storing data necessary for the arithmetic processing unit to execute a computer program, an operation unit such as a keyboard for an operator to perform various operations, and a display unit such as a display for displaying various information to the operator. The numerical control device 4 and the robot control device 5 can transmit and receive various signals to and from each other by Ethernet (registered trademark), for example.

FIG. 2 is a functional block diagram of the numerical control device 4 and the robot control device 5 according to the present embodiment, First, a detailed configuration of the numerical control device 4 will be described. As shown in FIG. 2, the numerical control device 4 realizes various functions such as a function of controlling the operation of the machine tool 2 and a function of generating an operation path of a control axis of the cooperative robot 3 by the above-described hardware configuration.

The numerical control device 4 controls the cooperative robot 3 via the robot control device 5 using the numerical control program. That is, the numerical control device 4 generates various commands for controlling the operations of the cooperative robot 3 and the tool 3b according to the numerical control program for the robot, and transmits the commands to the robot control device 5. More specifically, the numerical control device 4 includes a program input unit 41, an analysis unit 42, an operation control unit 43, a storage unit 44, a robot command signal generation unit 45, and a data transmission/reception unit 46.

The program input unit 41 reads a numerical control program for a robot constituted by a plurality of robot command blocks from the storage unit 44, and sequentially inputs the numerical control program to the analysis unit 42.

The analysis unit 42 analyzes the command type based on the numerical control program inputted from the program input unit 41 for each command block, and outputs the analysis result to the operation control unit 43 and the robot command signal generation unit 45. More specifically, when the command type of the command block is a machine tool numerical control command for the machine tool 2, the analysis unit 42 transmits the machine tool numerical control command to the operation control unit 43. When the command type of the command block is a robot numerical control command for the cooperative robot 3, the analysis unit 42 outputs the robot numerical control command (hereinafter, also referred to as a robot control command) to the robot command signal generation unit 45.

The operation control unit 43 generates a machine tool control signal for controlling the operation of the machine tool 2 according to the analysis result transmitted from the analysis unit 42, and inputs the machine tool control signal to an actuator that drives various axes of the machine tool 2. The machine tool 2 operates in response to a machine tool control signal inputted from the operation control unit 43 to machine a workpiece (not shown).

The storage unit 44 stores, for example, a plurality of numerical control programs created based on an operation by an operator. More specifically, the storage unit 44 stores a numerical control program including a plurality of command blocks for the machine tool 2 for controlling the operation of the machine tool 2, a plurality of command blocks for the cooperative robot 3 for controlling the operation of the cooperative robot 3, and the like. The numerical control program stored in the storage unit 44 is described in a known program language such as G code or M code for controlling the operation of the machine tool 2.

In addition, the storage unit 44 stores, for example, machine coordinate values indicating positions of various axes of the machine tool 2 operated under the numerical control program (that is, positions of a tool post, a table, and the like of the machine tool 2). These machine coordinate values are defined under a machine tool coordinate system having a reference point defined at any position on the machine tool 2 or in the vicinity of the machine tool 2 as an origin. The storage unit 44 is sequentially updated by processing (not shown) so as to store the latest values of the machine coordinate values that sequentially change under the numerical control program.

The storage unit 44 stores, for example, robot coordinate values indicating the position and posture of a control point (for example, the arm tip portion 3a of the cooperative robot 3) of the cooperative robot 3 operated under the control of the robot control device 5, in other words, the position of each control axis of the cooperative robot 3. These robot coordinate values are defined under a robot coordinate system different from the machine tool coordinate system as described above. The storage unit 44 is sequentially updated with the robot coordinate values acquired from the robot control device 5 by processing (not shown) so as to store the latest values of the robot coordinate values that sequentially change under the numerical control program.

In addition, the storage unit 44 stores, for example, teaching positions such as a start point and an end point of the cooperative robot 3 inputted by the operator. Specifically, the storage unit 44 stores a teaching position of the cooperative robot 3 inputted from a teaching pendant or the like, a teaching position inputted from a keyboard or the like, and the like. The teaching position of the cooperative robot 3 includes robot coordinate values indicating the position of each control axis of the cooperative robot 3, and these robot coordinate values are defined under a robot coordinate system different from the machine tool coordinate system.

The robot command signal generation unit 45 generates a robot command signal for each robot command block based on the analysis result for each robot command block inputted from the analysis unit 42, and writes the generated robot command signal in the data transmission/reception unit 46.

Specifically, the robot command signal generation unit 45 generates a robot command signal for each robot command block based on the robot numerical control command as an analysis result inputted from the analysis unit 42, and writes the generated robot command signal in the data transmission/reception unit 46.

The data transmission/reception unit 46 transmits and receives various data such as commands and robot coordinate values to and from the data transmission/reception unit 60 of the robot control device 5. Specifically, the data transmission/reception unit 46 transmits the robot command signal generated by the robot command signal generation unit 45 to the data transmission/reception unit 60 of the robot control device 5.

Next, the configuration of the robot control device 5 will be described in detail. As shown in FIG. 2, in the robot control device 5, various functions such as a storage unit 51, an analysis unit 52, a robot instruction generation unit 53, a program management unit 54, a path control unit 55, a kinematics control unit 56, a servo control unit 57, a payload setting selection unit 58, a dynamics control unit 59, a data transmission/reception unit 60, a contact operation execution unit 61, and a contact control unit 62 are realized by the hardware configuration. The robot control device 5 controls the operation of the cooperative robot 3 based on a command transmitted from the numerical control device 4 by using these functional units.

The storage unit 51 stores a robot program for controlling the cooperative robot 3 and various kinds of information. In addition, the storage unit 51 stores payload settings of the cooperative robot 3. Although the storage unit 51 is provided in the robot control device 5 in the present embodiment, the storage unit 51 may be provided in the numerical control device 4, or may be provided in an electronic device, an external server, or the like outside the numerical control device 4 and the robot control device 5.

The data transmission/reception unit 60 receives the robot command signal transmitted from the data transmission/reception unit 46 of the numerical control device 4. Further, the data transmission/reception unit 60 sequentially outputs the received robot command signal to the analysis unit 52.

The analysis unit 52 analyzes the robot command signal inputted from the data transmission/reception unit 60. Further, the analysis unit 52 outputs the analysis result to the robot instruction generation unit 53.

The robot instruction generation unit 53 generates a robot instruction according to the robot command signal based on the analysis result of the robot command signal inputted from the analysis unit 52. The robot instruction generation unit 53 outputs the generated robot instruction to the program management unit 54.

When the robot instruction is inputted from the robot instruction generation unit 53, the program management unit 54 sequentially executes the robot instruction to generate an operation plan of the cooperative robot 3 according to the robot command signal, and outputs the operation plan to the path control unit 55.

Further, in a case where the robot instruction inputted from the robot instruction generation unit 53 is a block robot instruction, the program management unit 54 adds the inputted block robot instruction to the robot program stored in the storage unit 51. As a result, a robot program corresponding to the robot command signal transmitted from the numerical control device 4 is generated and stored in the storage unit 51. The stored robot program is activated and reproduced when the program management unit 54 receives a robot program activation command as a robot instruction.

In addition, the program management unit 54 reads and executes the robot program including the contact skip operation command from the storage unit 51. Here, the contact skip operation command includes an external force threshold for stopping the cooperative robot 3 when the cooperative robot 3 detects an external force.

In addition, the contact skip operation indicates that the cooperative robot 3 stops the movement of the cooperative robot 3 and executes the next command block when the cooperative robot 3 detects an external force by a contact operation such as contacting an object during the movement of the cooperative robot 3.

When the operation plan is inputted from the program management unit 54, the path control unit 55 calculates time-series data of the control points of the cooperative robot 3, and outputs the time-series data to the kinematics control unit 56.

The kinematics control unit 56 calculates a target angle of each joint of the cooperative robot 3 from the inputted time-series data, and inputs the target angle to the servo control unit 57.

The servo control unit 57 generates a robot control signal for the cooperative robot 3 by feedback-controlling each servo motor of the cooperative robot 3 so that the target angle inputted from the kinematics control unit 56 is realized, and inputs the robot control signal to the servo motor of the cooperative robot 3. Further, the servo control unit 57 generates a robot control signal reflecting the torque calculated by the dynamics control unit 59 described later. Accordingly, the robot control device 5 can control the cooperative robot 3 based on the payload setting.

The payload setting selection unit 58 selects the payload setting stored in the storage unit 51 in response to the robot command signal analyzed by the analysis unit 52, and notifies the dynamics control unit 59 of the selected payload setting.

The dynamics control unit 59 calculates torque to be inputted to the cooperative robot 3 by inverse dynamics calculation based on the payload setting selected by the payload setting selection unit 58. The dynamics control unit 59 outputs the torque obtained by the calculation to the servo control unit 57.

Here, the inverse dynamics calculation of the cooperative robot 3 is a method of calculating the input torque to each motor for realizing such a response in consideration of the hand payload, the gravity, and the weight applied to the cooperative robot 3 based on the desired motion (time-series data of the position, the speed, and the acceleration of each joint) calculated by the operation path plan of the cooperative robot 3, For example, a numerical calculation method such as a calculation torque method or a Newton-Euler method is disclosed as a method relating to such inverse dynamics calculation (for example, Japanese Unexamined Patent Application, Publication Nos. H8-118275 and 2015-58520).

In a case where the external force detected by the cooperative robot 3 exceeds the external force threshold during the movement of the cooperative robot 3 according to the contact skip operation command in the robot program, the contact operation execution unit 61 stops the movement of the cooperative robot 3, and executes the next command block of the robot program.

The contact control unit 62 controls the contact stop operation according to the detection result of the external force by the external force detection unit 31 in the cooperative robot 3. Here, the contact stop operation indicates that the cooperative robot 3 stops the operation of the cooperative robot 3 in response to an external contact force.

The contact skip operation command includes an external force threshold for stopping the cooperative robot 3 when the cooperative robot 3 detects an external force, an operation type of the cooperative robot 3, a target position of the cooperative robot 3, a movement speed of the cooperative robot 3, a contact position where the cooperative robot 3 contacts an object, and the like.

Further, the contact skip operation command may include designating a force component or a torque component when the cooperative robot 3 detects an external force according to the moving direction or the movement speed of the cooperative robot 3. For example, when the cooperative robot 3 moves in the +X direction, the contact skip operation command may designate a force component or a torque component in the +X direction when the external force detection unit 31 detects the external force.

In addition, the contact skip operation command may include setting the external force threshold of the contact skip operation to be smaller than the external force detection threshold of the contact stop operation in which the operation of the cooperative robot 3 is stopped by an external contact.

In addition, the next command block of the robot program may include acquiring two positions at which the cooperative robot 3 detects the contact during the contact skip operation, and measuring the dimension of the object according to the acquired two positions. Here, the two positions may be, for example, a first position where a contact is detected while the cooperative robot 3 is moving in the +X direction, and a second position where a contact is detected while the cooperative robot 3 is moving in the − (minus symbol) X direction. Accordingly, the robot control device 5 can measure the dimension of the object in the X direction from the two positions.

In addition, the next command block of the robot program may include, for example, the cooperative robot 3 grasping a workpiece of unknown dimensions, or grasping the workpiece at a position where the cooperative robot 3 contacts the workpiece while searching for the position of the workpiece.

Next, specific processing of the contact skip operation will be described. The program management unit 54 executes the robot program, and notifies the contact operation execution unit 61 of the contact skip operation command when the contact skip operation command is present in the robot program.

When the external force detected by the cooperative robot 3 exceeds the external force threshold during the movement of the cooperative robot 3, according to the contact skip operation command, the contact operation execution unit 61 notifies the contact control unit 62 of the external force threshold, and the contact control unit 62 starts monitoring the external force exceeding the external force threshold.

In addition, the contact operation execution unit 61 notifies the robot instruction generation unit 53 of the operation type, the movement amount, and the movement speed of the cooperative robot 3 in response to the contact skip operation signal, and the robot instruction generation unit 53 generates a robot instruction according to the operation type, the movement amount, and the movement speed of the cooperative robot 3. Thereafter, the robot control device 5 performs the above-described control, and the cooperative robot 3 starts moving.

In a case where the external force detected by the external force detection unit 31 exceeds the external force threshold, the contact control unit 62 notifies the servo control unit 57 that the movement is to be stopped, and acquires the positional information of the position at which the external force detection unit 31 detects the external force exceeding the external force threshold.

The contact control unit 62 notifies the contact operation execution unit 61 of the acquired positional information and an event that the cooperative robot 3 has stopped. The contact operation execution unit 61 notifies the program management unit 54 of the acquired positional information and an event that the cooperative robot 3 has stopped.

Then, as described above, when notified from the contact operation execution unit 614 that the cooperative robot 3 has stopped moving, the program management unit 54 executes the next command block of the robot control command. Further, the program management unit 54 executes, for example, the next command block, and measures the dimensions of the object based on the positional information of the object acquired.

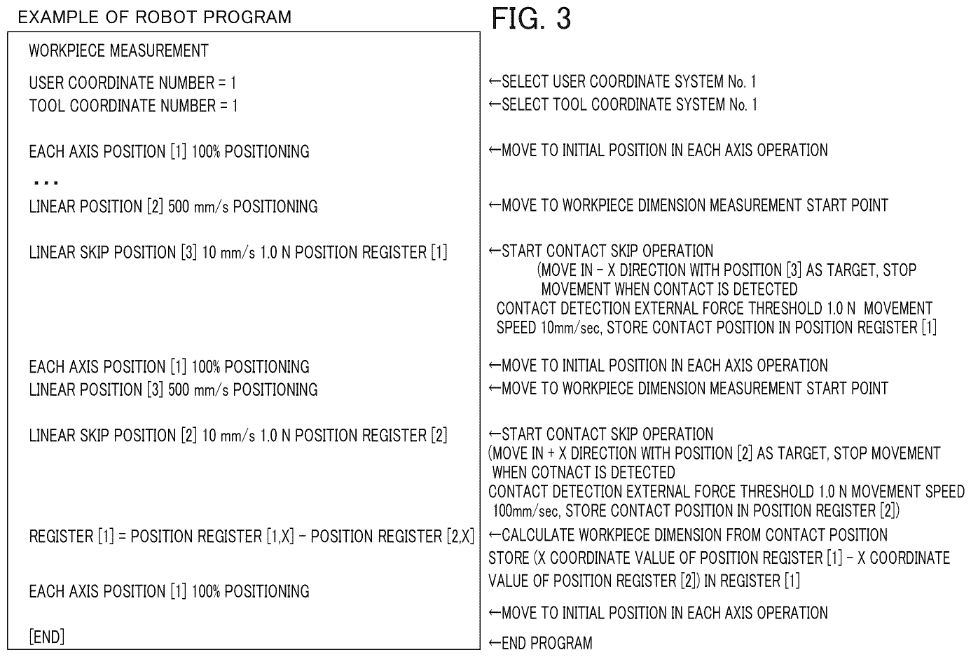

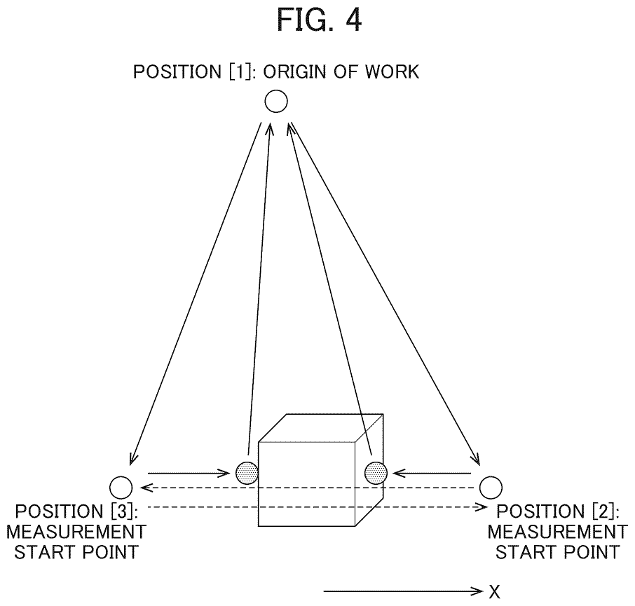

FIG. 3 is a diagram showing an example of a robot program according to the present embodiment. FIG. 4 is a diagram schematically showing the operation of the cooperative robot 3 when the robot program shown in FIG. 3 is executed. In the robot program shown in FIG. 3, the cooperative robot 3 measures the dimensions of the workpiece as the object by using the contact skip operation command.

First, “User Coordinate Number=1” is commanded, and the cooperative robot 3 selects the user coordinate system No. 1. Next, “Tool Coordinate Number=1” is commanded, and the cooperative robot 3 selects the tool coordinate system No. 1.

Next, “Each Axis Position [1] 100% Positioning” is commanded, and the robot control device 5 moves and positions the cooperative robot 3 to the initial position (Position [1]) by each axis operation of the cooperative robot 3. Next, “Linear Position [2] 500 mm/s positioning” is commanded, and the robot control device 5 linearly moves and positions the cooperative robot 3 to the workpiece dimension measurement start point (Position [2]) at a speed of 500 mm/sec.

Next, “Linear Skip Position [3] 10 mm/s 1.0 N Position Register [1]” is commanded, and the cooperative robot 3 and the robot control device 5 start the contact skip operation. This command moves the cooperative robot 3 in the −X direction with the Position [3] as a target, and stops the movement of the cooperative robot 3 when the external force detection unit 31 detects an external force. Further, the command sets the external force threshold for detecting the external force to 1.0 N, and sets the movement speed of the cooperative robot 3 to 10 mm/sec.

In response to this command, the robot control device 5 causes the cooperative robot 3 to start moving at a speed of 10 mm/see in the −X direction by linear motion with Position [3] as a target. Then, the robot control device 5 stops the movement of the cooperative robot 3 when the external force exceeding 1.0 N is detected, and stores the positional information of the position at which the external force was detected in Position Register [1].

Next, “Each Axis Position [1] 100% Positioning” is commanded, and the robot control device 5 moves and positions the cooperative robot 3 to the initial position (Position [1]) by each axis operation of the cooperative robot 3.

Next, “Linear Position [3] 500 mm/s Positioning” is commanded, and the robot control device 5 linearly moves and positions the cooperative robot 3 to the workpiece dimension measurement start point (Position [3]) at a speed of 500 mm/sec.

Next, “Linear Skip Position [2] 10 mm/s 1.0 N Position Register [2]” is commanded, and the cooperative robot 3 and the robot control device 5 start the contact skip operation. This command moves the cooperative robot 3 in the +X direction with Position [2] as a target, and stops the movement of the cooperative robot 3 when the external force detection unit 31 detects the external force. Further, the command sets the external force threshold for detecting the external force to 1.0 N, and sets the movement speed of the cooperative robot 3 to 10 mm/sec.

In response to this command, the robot control device 5 causes the cooperative robot 3 to start moving at a speed of 10 mm/sec in the +X direction by linear movement with Position [2] as a target. Then, the robot control device 5 stops the movement of the cooperative robot 3 when the external force exceeding 1.0 N is detected, and stores the positional information of the position at which the external force was detected in Position Register [2].

Next, “Register [1]=Position Register [1, X]−Position Register [2, X]” is commanded, and the robot control device 5 measures the dimensions of the workpiece from the positional information of the position where the external force is detected. That is, the robot control device 5 subtracts the X coordinate value of Position Register [2] from the X coordinate value of Position Register [1], and stores the value in Register [1].

Next, “Each Axis Position [1] 100% Positioning” is commanded, and the robot control device 5 moves and positions the cooperative robot 3 to the initial position (Position [1]) by each axis operation of the cooperative robot 3. Then, “[End]” is commanded, and the robot program ends. In this way, the robot program can measure the dimensions of the workpiece by performing the contact skip operation from Position [2] and Position [3] shown in FIG. 4.

As described above, according to the present embodiment, the robot control device 5 includes the program management unit 54 that executes a robot program including a contact skip operation command, the contact skip operation command including an external force threshold for stopping the cooperative robot 3 when the cooperative robot 3 detects an external force, and the contact operation execution unit 61 that, according to the contact skip operation command, when the external force detected by the cooperative robot 3 exceeds the external force threshold during a movement of the cooperative robot 3, stops the movement of the cooperative robot 3 and executes a next command block of the robot program.

With such a configuration, the robot control device 5 sets the threshold of the external force applied to the cooperative robot 3 according to the command in the robot program, moves the cooperative robot 3, and stops the movement of the cooperative robot 3 when the cooperative robot 3 moves and the external force is detected. This makes it possible for the robot control device 5 to detect the contact with the object, and to execute the continuous robot program by executing the command of the next block after the detection of the contact.

In addition, the next command block of the robot program may include acquiring a position at which the cooperative robot 3 detects the contact during the contact skip operation, and measuring the dimensions of the object according to the acquired position. With such a configuration, it is possible for the robot control device 5 to measure the dimensions of an object such as a workpiece machined by the machine tool 2.

In addition, the contact skip operation command may include designating a force component or a torque component when the external force detection unit 31 of the cooperative robot 3 detects the external force according to the movement direction or the movement speed of the cooperative robot 3. With such a configuration, it is possible for the robot control device 5 to measure the dimensions of the target object for the designated component.

In addition, the contact skip operation command may include setting the external force threshold of the contact skip operation to be smaller than the external force detection threshold of the contact stop operation in which the operation of the cooperative robot 3 is stopped due to an external contact. With such a configuration, it is possible for the numerical control device 4 to measure the dimensions of the object without stopping the operation when the cooperative robot 3 comes into contact with the object.

Although embodiments of the present invention have been described above, the numerical control system 1 can be realized by hardware, software, or a combination thereof. The control method performed by the numerical control system 1 can also be realized by hardware, software, or a combination thereof. Here, being implemented by software indicates being implemented by a computer reading and executing a program.

The program may be stored and provided to the computer using various types of non-transitory computer readable media (non-transitory computer readable medium). Non-transitory computer readable media include various types of tangible storage media. Examples of non-transitory computer-readable media include magnetic recording media (e.g., a hard disk drive), magneto-optical recording media (e.g., a magneto-optical disk), CD-ROMs (read only memory), CD-Rs, CD-R/Ws, and semiconductor memory (for example, mask ROM, programmable ROM (PROM), erasable PROM (EPROM), flash ROM, and random access memory (RAM)).

Although the present disclosure has been described in detail, the present disclosure is not limited to the individual embodiments described above. Various additions, substitutions, modifications, partial deletions, and the like can be made to these embodiments without departing from the gist of the present disclosure or the gist of the present disclosure derived from the contents described in the claims and the equivalents thereof. These embodiments can also be implemented in combination. For example, in the above-described embodiments, the order of each operation and the order of each process are shown as an example, and are not limited thereto. The same applies to the case where numerical values or numerical expressions are used in the description of the above-described embodiment.

The following Supplementary Notes are further disclosed with respect to the above-described embodiments and modifications.

### (Supplementary Note 1)

The robot control device (5) includes: the program management unit (54) that executes a robot program including a contact skip operation command, the contact skip operation command including an external force threshold for stopping a robot when the robot detects an external force; and the contact operation execution unit (61) that, according to the contact skip operation command, when the external force detected by the robot exceeds the external force threshold during a movement of the robot, stops the movement of the robot and executes a next command block of the robot program.

### (Supplementary Note 2)

In the robot control device as described in Supplementary Note 1, the next command block of the robot program includes acquiring a position at which the robot detects a contact during a contact skip operation, and measuring a dimension of an object according to the position acquired.

### (Supplementary Note 3)

In the robot control device as described in Supplementary Note 1, the contact skip operation command includes designating a force component or a torque component when the robot detects an external force according to a movement direction or a movement speed of the robot.

### (Supplementary Note 4)

In the robot control device as described in Supplementary Note 1, the robot is a cooperative robot that stops an operation upon detecting a contact with a person, and the contact skip operation command includes setting an external force threshold of the contact skip operation to be smaller than an external force detection threshold of a contact stop operation in which the cooperative robot stops an operation due to an external contact.

### EXPLANATION OF REFERENCE NUMERALS

1 Numerical Control System
2 Machine Tool
3 Cooperative Robot
4 Numerical Control Device
5 Robot Control Unit
31 External Force Detection Unit
41 Program Input Unit
42 Analysis Unit
43 Operation Control Unit
44 Storage Unit
45 Robot Command Signal Generation Unit
46 Data Transmission/reception Unit
51 Storage Unit
52 Analysis Unit
53 Robot Instruction Generation Unit
54 Program Management Unit
55 Path Control Unit
56 Kinematics Control Unit
57 Servo Control Unit
58 Payload Setting Selection Unit
59 Dynamics Control Unit
60 Data Transmission/reception Unit
61 Contact Operation Execution Unit
62 Contact Control Unit

1. A robot control device comprising:
a program management unit that executes a robot program including a contact skip operation command, the contact skip operation command including an external force threshold for stopping a robot when the robot detects an external force; and
a contact operation execution unit that, according to the contact skip operation command, when the external force detected by the robot exceeds the external force threshold during a movement of the robot, stops the movement of the robot and executes a next command block of the robot program.

2. The robot control device according to claim 1, wherein the next command block of the robot program includes acquiring a position at which the robot detects a contact during a contact skip operation, and measuring a dimension of an object according to the position acquired.

3. The robot control device according to claim 1, wherein the contact skip operation command includes designating a force component or a torque component when the robot detects an external force according to a movement direction or a movement speed of the robot.

4. The robot control device according to claim 1, wherein the robot is a cooperative robot that stops an operation upon detecting a contact with a person, and
the contact skip operation command includes setting an external force threshold of the contact skip operation to be smaller than an external force detection threshold of a contact stop operation in which the cooperative robot stops an operation due to an external contact.
